(19) United States
(12) Patent Application Publication
(10) Pub. No.: US 2024/0371165 A1
(43) Pub. Date: Nov. 7, 2024

(54) SYSTEMS AND METHODS FOR SCENE BOUNDARY DETECTION

(71) Applicant: Netflix, Los Gatos, CA (US)

(72) Inventors: Avneesh Singh Saluja, San Diego, CA (US); Andy Yao, Pleasanton, CA (US); Mohammad Hossein Taghavi Nasrabadi, San Jose, CA (US)

(21) Appl. No.: 18/651,486

(22) Filed: Apr. 30, 2024

Related U.S. Application Data
(60) Provisional application No. 63/499,473, filed on May 1, 2023.

(51) Int. Cl. G06V 20/40; G06V 10/77; G06V 10/82

(52) U.S. Cl. CPC G06V 20/47; G06V 10/7715; G06V 10/82; G06V 20/49

(57) ABSTRACT

The disclosed computer-implemented method may include identifying a first set of embeddings and a second set of embeddings for a video, wherein the second set of embeddings comprises a different data type from the first set of embeddings. The method may also include encoding the first set of embeddings with a first sequence model trained for a first data type and the second set of embeddings with a second sequence model trained for the different data type. Additionally, the method may include concatenating a set of first results of the first sequence model with a set of second results of the second sequence model. Furthermore, the method may include detecting, based on the concatenation, a segment boundary of the video using a neural network. Finally, the method may include performing additional video processing based on the detected segment boundary. Various other methods, systems, and computer-readable media are also disclosed.

### CROSS REFERENCE TO RELATED APPLICATION

This application claims the benefit of U.S. Provisional Application No. 63/499,473, filed 1 May 2023, the disclosure of which is incorporated, in its entirety, by this reference.

### BACKGROUND

Long-form videos, such as movies and episodic shows, often use different structures to present a narrative. Typically, these videos are composed of smaller elements, like shots and scenes, that combine to form higher level elements. For example, a scene can include multiple shots that share a location and a cast of characters. To perform tasks like video summarization, highlights detection, content-based video retrieval, or other types of video processing, it may be necessary to understand the relationships between these elements. For example, with the advent of online digital media streaming, a streaming platform may need to generate trailers or preview clips for videos. Manually performing these types of tasks can be inefficient and time-consuming.

Some systems attempt to automate these tasks using computational models or other techniques. For example, some methods automate the segmentation of granular units like frames or shots by using pixel-based information. However, because long-form content can contain more complex narrative structures, models that rely on such data may be insufficient for higher order segmentation that requires a more nuanced understanding of content and context. For example, automating the segmentation of a scene or an act may require an understanding of the narrative or emotional arcs of a video.

In some instances, models to automate segmentation may attempt to create a framework that incorporates many different features of videos. However, these models often have inductive biases and may not account for dependencies in data. For example, scenes are rarely a single shot, but each shot of a scene may take place at the same location with the same set of characters and may share a common action or theme. Additionally, models that rely on information like screenplays may not account for changes made either on-the-fly or during post-production. For example, on-the-fly changes may result in differences in dialogue between a screenplay and a video, and post-shoot changes may result in more significant changes like reordering of scenes. These types of models may also assume high-quality screenplays are available, which is often not the case. Thus, better methods of automating video segmentation and boundary detection are needed to avoid the costly process of manual processing.

### SUMMARY

As will be described in greater detail below, the present disclosure describes systems and methods for predicting video segment boundaries for video processing tasks. In one example, a computer-implemented method for scene boundary detection may include identifying, by a computing device, a first set of embeddings and at least one second set of embeddings for a video, wherein a second set of embeddings comprises a different data type from a data type of the first set of embeddings. The method may also include encoding, by the computing device, the first set of embeddings with a first sequence model trained for the data type of the first set of embeddings and the second set of embeddings with a second sequence model trained for the different data type of the second set of embeddings. In addition, the method may include concatenating, by the computing device, a set of first results of the first sequence model with a set of second results of the second sequence model. Furthermore, the method may include detecting, by the computing device based on the concatenation, a segment boundary of the video using a neural network. Finally, the method may include performing, by the computing device, additional video processing for the video based on the detected segment boundary.

In one embodiment, the data type of the first or second sets of embeddings may include a type of video, a type of audio, a type of image, a type of text, and/or metadata about the video. In this embodiment, each embedding may include a vector representing the data type for a subsegment unit of the video, wherein a segment of the video comprises at least one subsegment unit. In this embodiment, the subsegment unit of the video may include a frame, a shot, a scene, a sequence, and/or an act.

In one example, encoding the first set of embeddings may include processing an embedding of the first set of embeddings at a layer of the first sequence model, providing an output of each layer to a next layer of the first sequence model, and processing a subsequent embedding of the first set of embeddings at the next layer of the first sequence model, wherein the subsequent embedding represents a chronologically following subsegment unit of the video. In this example, the set of first results may include a set of outputs of each layer of the first sequence model.

Similarly, in one example, encoding the second set of embeddings may include processing an embedding of the second set of embeddings at a layer of the second sequence model, providing an output of each layer to a next layer of the second sequence model, and processing a subsequent embedding of the second set of embeddings at the next layer of the second sequence model, wherein the subsequent embedding represents a chronologically following subsegment unit of the video. In this example, the set of second results may include a set of outputs of each layer of the second sequence model.

In some embodiments, concatenating the set of first results with the set of second results may include concatenating each first result for the subsegment unit of the video with a corresponding second result for the subsegment unit of the video.

In one embodiment, detecting the segment boundary may include identifying a boundary subsegment unit as the segment boundary for a detected segment of the video, wherein the segment boundary may include a chronological beginning of the detected segment or a chronological end of the detected segment. In this embodiment, detecting the segment boundary may include calculating a boundary probability for each subsegment unit of the video and determining that the boundary probability of the boundary subsegment unit exceeds a predetermined threshold.

In some examples, the computer-implemented method may further include identifying a third set of embeddings, wherein the third set of embeddings includes external data related to the video, and encoding the third set of embeddings with a third sequence model trained for the external data. In these examples, the computer-implemented method may include concatenating a set of third results of the third sequence model with the set of first results and the set of second results and then detecting the segment boundary of the video using the concatenation of the set of first results, the set of second results, and the set of third results.

In some embodiments, the computer-implemented method may further include retraining the neural network based on the detected segment boundary.

In addition, a corresponding system for scene boundary detection may include several modules stored in memory, including an identification module that identifies, by a computing device, a first set of embeddings and at least one second set of embeddings for a video, wherein the second set of embeddings comprises a different data type from a data type of the first set of embeddings. The system may also include an encoding module that encodes, by the computing device, the first set of embeddings with a first sequence model trained for the data type of the first set of embeddings and the second set of embeddings with a second sequence model trained for the different data type of the second set of embeddings. In addition, the system may include a concatenation module that concatenates, by the computing device, a set of first results of the first sequence model with a set of second results of the second sequence model. Furthermore, the system may include a detection module that detects, by the computing device based on the concatenation, a segment boundary of the video using a neural network. Additionally, the system may include a performance module that performs, by the computing device, additional video processing for the video based on the detected segment boundary. Finally, the system may include one or more processors that execute the identification module, the encoding module, the concatenation module, the detection module, and the performance module.

In one embodiment, the first sequence model may be trained with embeddings of additional videos of the data type. In some embodiments, the second sequence model may be trained with embeddings of additional videos of the different data type.

In one example, the detection module may detect the segment boundary of the video by learning a set of parameters for the first sequence model, the second sequence model, and the neural network. In this example, the detection module may apply the set of parameters to the video.

In some embodiments, the system may further include a training module, stored in memory, that retrains the first sequence model with the first set of embeddings and retrains the second sequence model with the second set of embeddings.

In some examples, the above-described method may be encoded as computer-readable instructions on a computer-readable medium. For example, a computer-readable medium may include one or more computer-executable instructions that, when executed by at least one processor of a computing device, may cause the computing device to identify a first set of embeddings and at least one second set of embeddings for a video, wherein the second set of embeddings comprises a different data type from a data type of the first set of embeddings. The instructions may also cause the computing device to encode the first set of embeddings with a first sequence model trained for the data type of the first set of embeddings and the second set of embeddings with a second sequence model trained for the different data type of the second set of embeddings. In addition, the instructions may cause the computing device to concatenate a set of first results of the first sequence model with a set of second results of the second sequence model. Furthermore, the instructions may cause the computing device to detect, based on the concatenation, a segment boundary of the video using a neural network. Finally, the instructions may cause the computing device to perform additional video processing for the video based on the detected segment boundary.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for scene boundary detection.

FIG. 2 is a block diagram of an exemplary computing device for scene boundary detection.

FIG. 3 is a block diagram of an exemplary segmentation of an exemplary video.

FIG. 4 is a block diagram of an exemplary training of exemplary sequence models.

FIG. 5 is a block diagram of exemplary encoding of exemplary embeddings.

FIG. 6 is a block diagram of exemplary detection of exemplary segment boundaries.

FIG. 7 is a block diagram of exemplary boundary detection using exemplary external data.

FIG. 8 is a block diagram of an exemplary content distribution ecosystem.

FIG. 9 is a block diagram of an exemplary distribution infrastructure within the content distribution ecosystem shown in FIG. 8.

FIG. 10 is a block diagram of an exemplary content player within the content distribution ecosystem shown in FIG. 8.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to scene boundary detection for videos. As will be explained in greater detail below, embodiments of the present disclosure may, by using sequence models trained for data embeddings, detect boundaries of video segments that account for sequential dependencies within segments. The disclosed systems and methods may first use embeddings that contain different types of data about a video. For example, the disclosed systems and methods may use embeddings of video imagery in conjunction with embeddings of dialogue audio and embeddings of background audio for each shot of a video. By using multimodal data, the systems and methods described herein may create a robust model that can use context clues from different modalities to predict transitions between segments of a video, such as predicting a final shot of a scene. In some examples, the disclosed systems and methods may use pretrained embeddings, such as pretrained multimodal shot embeddings, and pretrain sequence models to account for different modalities. For example, the systems and methods described herein may use embeddings converted from annotated scene change data. The disclosed systems and methods may then feed the embeddings of a video through the pretrained sequence models. For example, embeddings of video imagery may be used as inputs to a model trained to process videos, and embeddings of dialogue audio may be used as inputs to a model trained with natural language processing techniques.

The disclosed systems and methods may then perform late-stage concatenation to derive final predictions of segment boundaries. For example, the systems and methods described herein may fuse the separated encoded video and audio embeddings and concatenate the hidden states of the sequence models just prior to a final output layer. Furthermore, the disclosed systems and methods may detect a segment boundary using a neural network. For example, the final output layer may include a neural network that predicts a probability of each shot being the last shot of a scene. The disclosed systems and methods may then use the prediction to perform additional video processing tasks, such as automated creation of preview clips, video sorting for search queries, or other types of video editing. For example, by determining timestamps of the final shot in each scene, the disclosed systems and methods may automate the identification of appropriate breaks for advertisements.

The systems and methods described herein may improve the functioning of a computing device by using fewer model parameters to reduce the computational complexity of video processing tasks. In addition, these systems and methods may also improve the fields of video editing and automated boundary detection by leveraging rich embeddings and rich pretrained models in conjunction with a simpler prediction model that aggregates those rich pretrained embeddings to improve the accuracy of segment boundary detection. Thus, the disclosed systems and methods may improve over traditional methods of scene boundary detection that use more complicated approaches to aggregation.

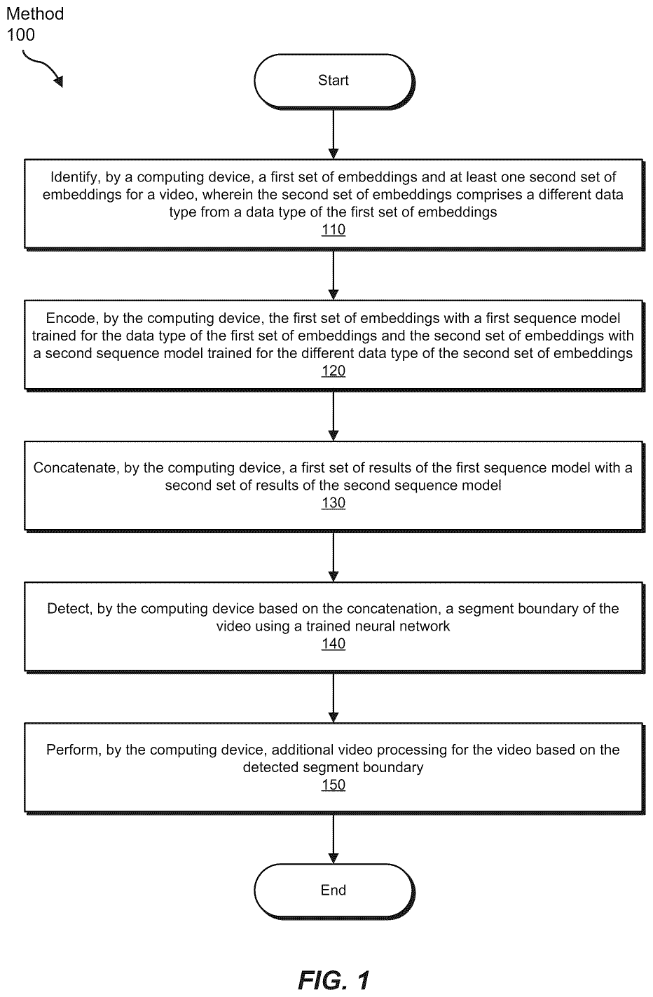

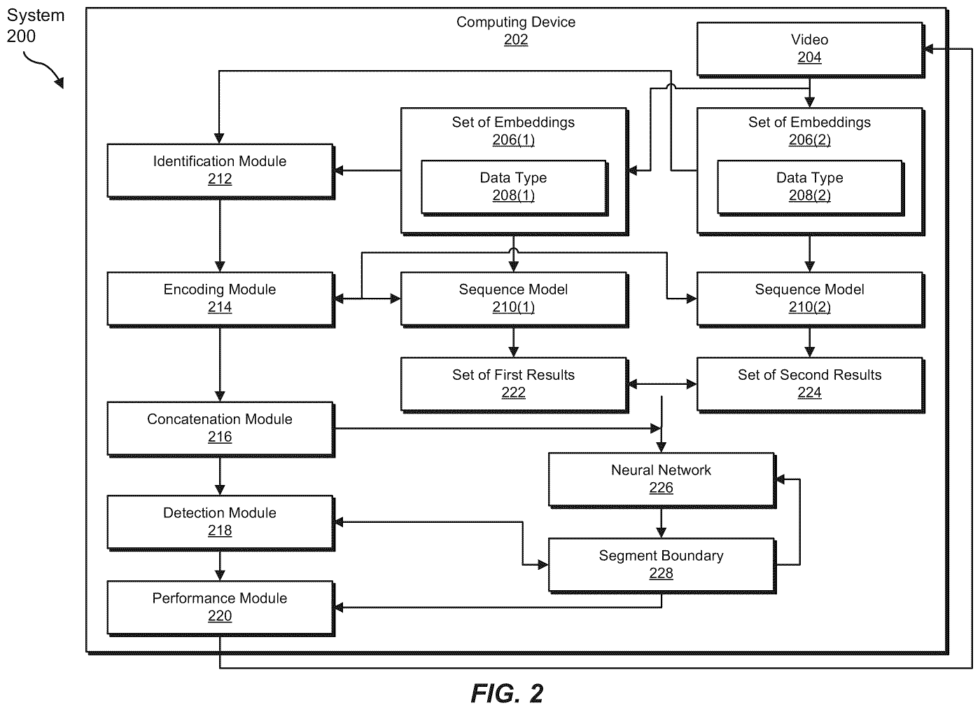

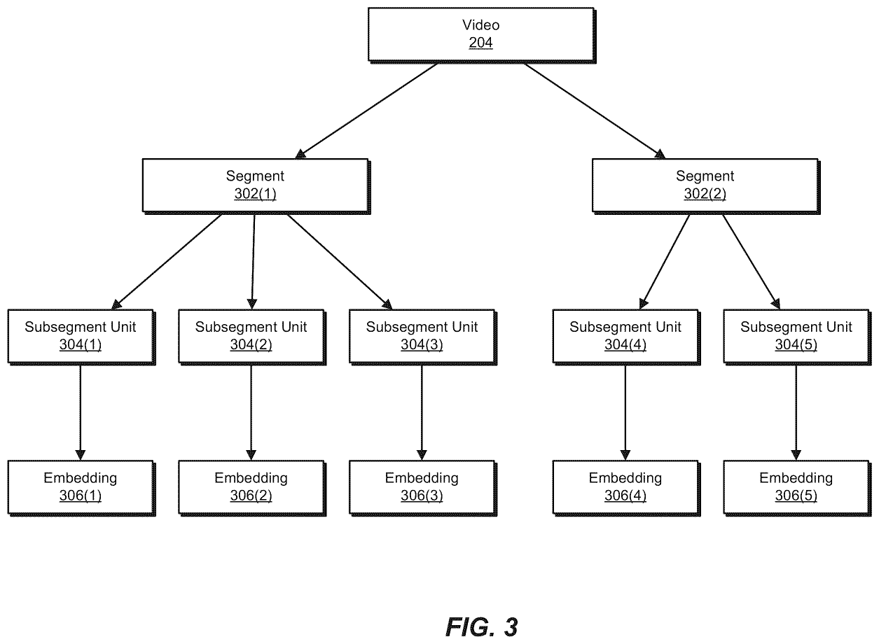

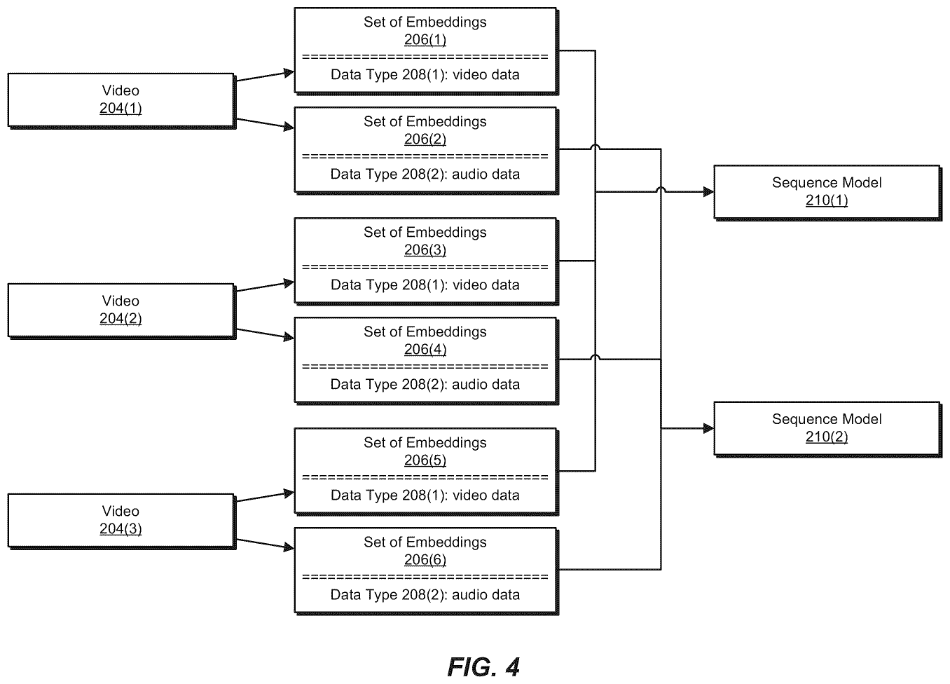

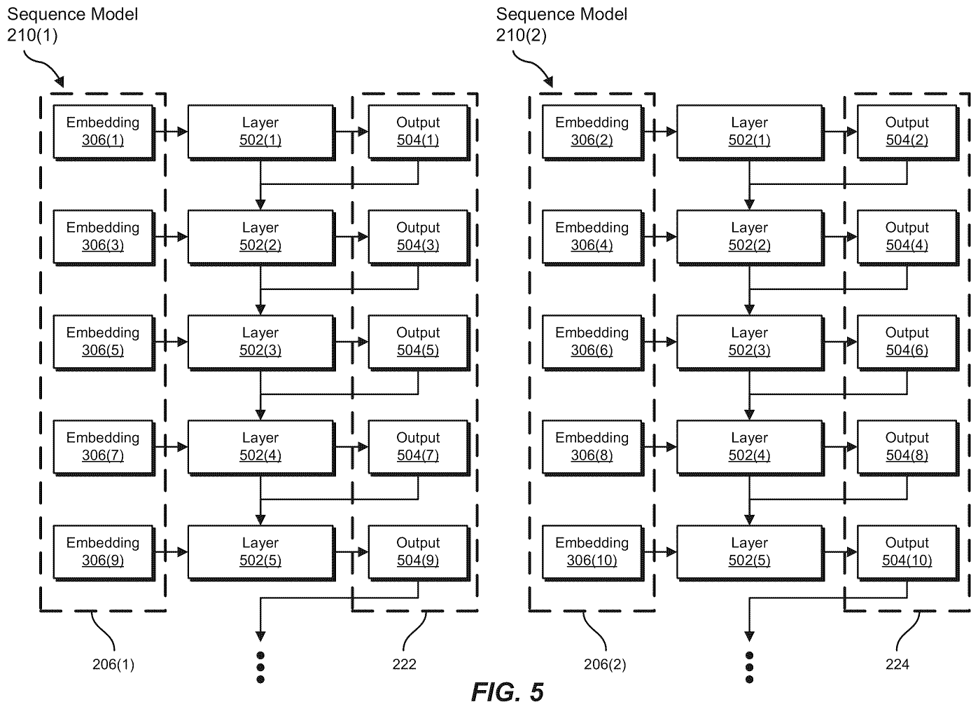

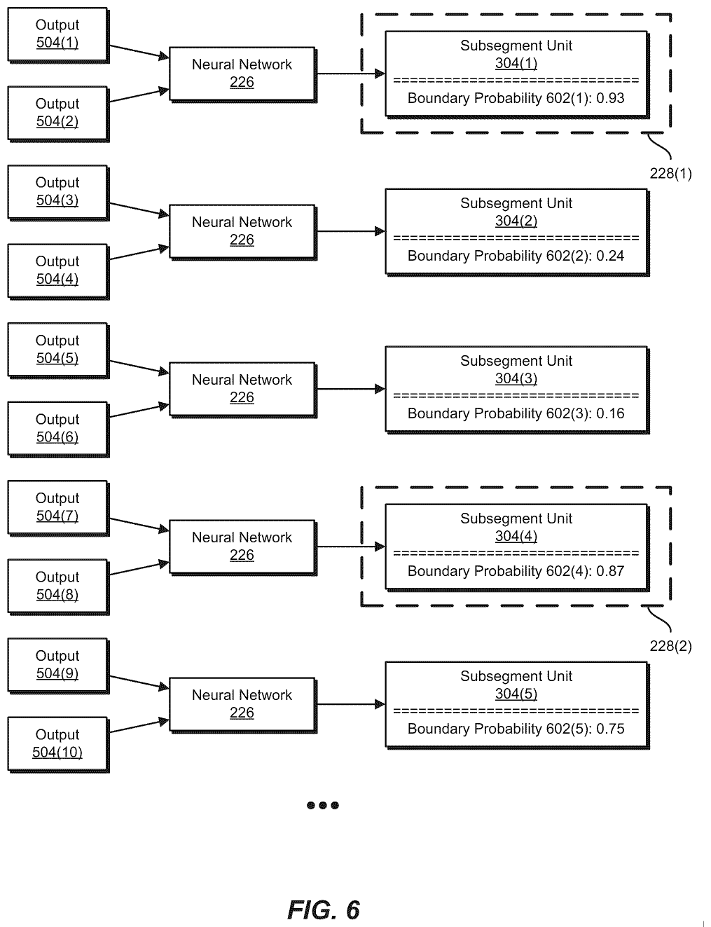

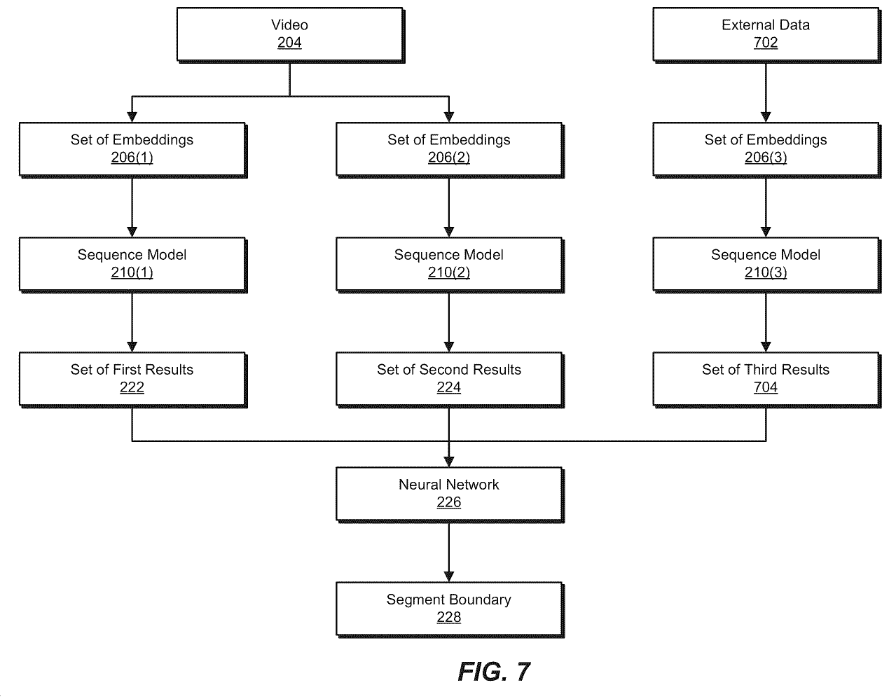

Thereafter, the description will provide, with reference to FIG. 1, detailed descriptions of computer-implemented methods for scene boundary detection. Detailed descriptions of a corresponding exemplary computing device will be provided in connection with FIG. 2. Detailed descriptions of an exemplary segmentation of an exemplary video will be provided in connection with FIG. 3. In addition, detailed descriptions of an exemplary training of exemplary sequence models will be provided in connection with FIG. 4. Detailed descriptions of exemplary encoding of exemplary embeddings will be provided in connection with FIG. 5. Furthermore, detailed descriptions of exemplary detection of exemplary segment boundaries will be provided in connection with FIG. 6. Additionally, detailed descriptions of exemplary boundary detection using exemplary external data will be provided in connection with FIG. 7.

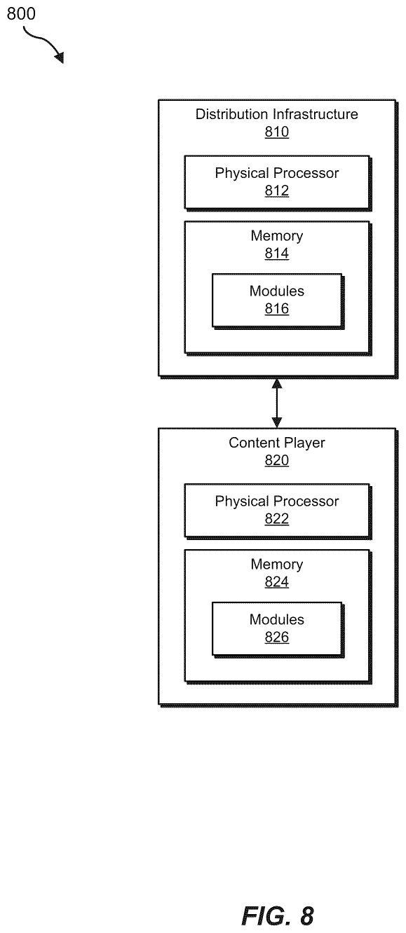

Because many of the embodiments described herein may be used with substantially any type of computing network, including distributed networks designed to provide video content to a worldwide audience, various computer network and video distribution systems will initially be described with reference to FIGS. 8-10. These figures will introduce the various networks and distribution methods used to provision video content to users.

FIG. 1 is a flow diagram of an exemplary computer-implemented method 100 for scene boundary detection. The steps shown in FIG. 1 may be performed by any suitable computer-executable code and/or computing system, including the systems illustrated in FIGS. 8-10, computing device 202 in FIG. 2, or a combination of one or more of the same. In one example, each of the steps shown in FIG. 1 may represent an algorithm whose structure includes and/or is represented by multiple sub-steps, examples of which will be provided in greater detail below. In some examples, all of the steps and sub-steps represented in FIG. 1 may be performed by one device (e.g., either a server or a client computing device). Alternatively, the steps and/or substeps represented in FIG. 1 may be performed across multiples devices (e.g., some of steps and/or sub-steps may be performed by a server and other steps and/or sub-steps may be performed by a client computing device).

As illustrated in FIG. 1, at step 110, one or more of the systems described herein may identify, by a computing device, a first set of embeddings and at least one second set of embeddings for a video, wherein a second set of embeddings comprises a different data type from a data type of the first set of embeddings. For example, FIG. 2 is a block diagram of an exemplary system 200 for scene boundary detection. As illustrated in FIG. 2, an identification module 212 may, as part of a computing device 202, identify a set of embeddings 206(1) of a data type 208(1) and a set of embeddings 206(2) of a data type 208(2) for a video 204.

In some embodiments, computing device 202 may generally represent any type or form of computing device capable of running computing software and applications. Examples of computing device 202 may include, without limitation, laptops, tablets, desktops, servers, cellular phones, Personal Digital Assistants (PDAs), multimedia players, embedded systems, wearable devices (e.g., smart watches, smart glasses, etc.), gaming consoles, combinations of one or more of the same, or any other suitable computing device.

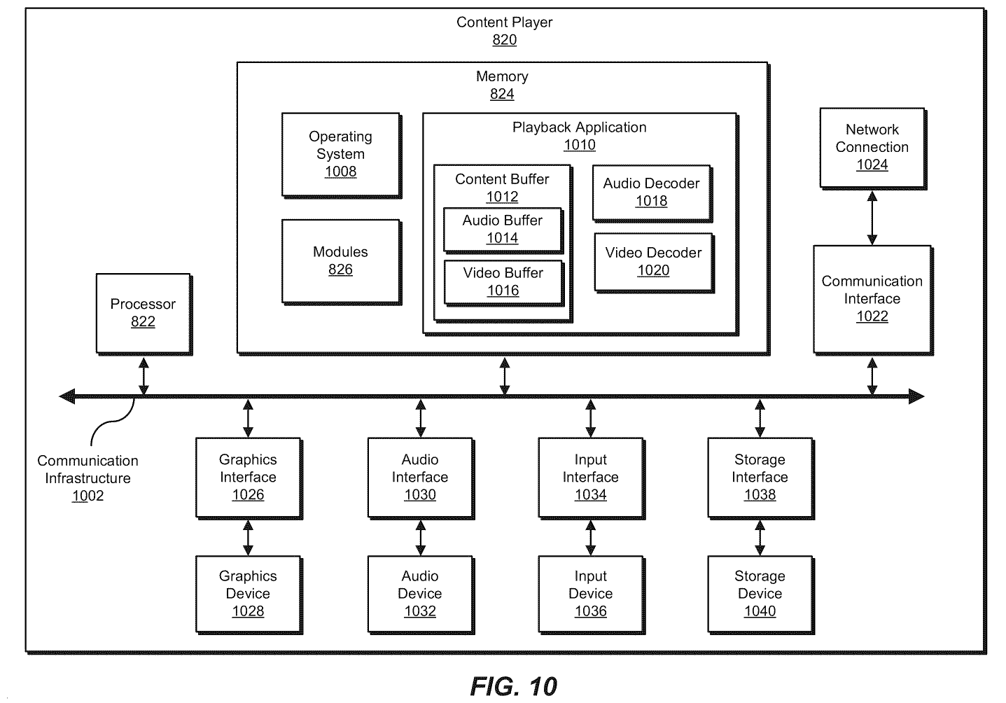

As used herein, the term “application” generally refers to a software program designed to perform specific functions or tasks and capable of being installed, deployed, executed, and/or otherwise implemented on a computing system. Examples of applications may include, without limitation, playback application 1010 of FIG. 10, productivity software, enterprise software, entertainment software, security applications, cloud-based applications, web applications, mobile applications, content access software, simulation software, integrated software, application packages, application suites, variations or combinations of one or more of the same, and/or any other suitable software application.

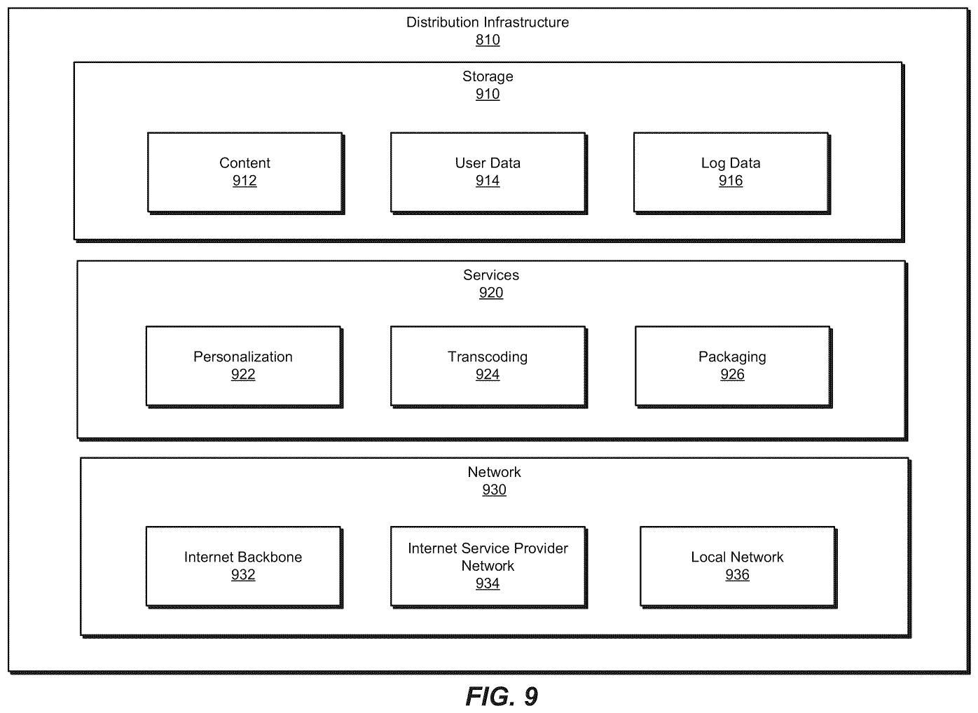

In the above embodiments, computing device 202 may be directly in communication with a server and/or in communication with other computing devices via a network. In some examples, the term “network” may refer to any medium or architecture capable of facilitating communication or data transfer. Examples of networks include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), network 930 of FIG. 9, or any other suitable network. For example, the network may facilitate data transfer between computing device 202 and other devices using wireless or wired connections.

Computing device 202 may alternatively generally represent any type or form of server that is capable of storing and/or managing data, such as storing and/or processing videos and training and/or storing sequence models 210(1)-(2) and/or neural network 226. Examples of a server include, without limitation, application servers and database servers configured to provide various database services and/or run certain software applications, such as communication and data transmission services. Additionally, computing device 202 may include content player 820 in FIGS. 8 and 10, distribution infrastructure 810, and/or various other components of FIGS. 8-10.

Although illustrated as part of computing device 202 in FIG. 2, some or all of the modules described herein may alternatively be executed by a server or any other suitable computing device. For example, identification module 212 may identify sets of embeddings 206(1)-(2) on computing device 202 to encode with sequence models on other computing devices or servers. Alternatively, identification module 212 may preprocess sets of embeddings 206(1)-(2) on a server and send sets of embeddings 206(1)-(2) to computing device 202.

The systems described herein may perform step 110 in a variety of ways. The term “embedding,” as used herein, generally refers to a representation of a value or a type of object and/or data that can be used by machine learning models. The term “machine learning,” as used herein, generally refers to a computational algorithm that may learn from data in order to make predictions. Examples of machine learning may include, without limitation, support vector machines, neural networks, clustering, decision trees, regression analysis, classification, variations or combinations of one or more of the same, and/or any other suitable supervised, semi-supervised, or unsupervised methods. The term “machine learning model,” as used herein, generally refers to a model built using machine learning methods.

In some embodiments, data types 208(1)-(2) may include a type of video, a type of audio, a type of image, a type of text, and/or metadata about the video. For example, as illustrated in FIG. 4, set of embeddings 206(1) includes data type 208(1) of video data, and set of embeddings 206(2) includes data type 208(2) of audio data. As another example, set of embeddings 206(1) may include foreground audio data that includes dialogue, and set of embeddings 206(2) may include background audio data that includes music and sound effects. Data types 208(1)-(2) may include various other modalities of data that provide information about videos, such as timed text, closed caption text, character information, and/or any other suitable data.

In some examples, each embedding may include a vector representing the data type for a subsegment unit of video 204, wherein a segment of video 204 includes one or more subsegment units. In these examples, the subsegment unit of video 204 may include a frame, a shot, a scene, a sequence, and/or an act. For example, to segment scenes, a subsegment unit may represent a shot. In contrast, to segment an act, a subsegment unit may represent a sequence. In some examples, the subsegment unit may represent a lower level of segmentation, such as using subsegment units of frames to detect scene boundaries.

As illustrated in FIG. 3, video 204 may be naturally divided into segments 302(1) and 302(2). In this example, segment 302(1) includes subsegment units 304(1)-(3), and segment 302(2) includes subsegment units 304(4)-(5). For example, segments 302(1)-(2) may represent scenes and subsegment units 304(1)-(5) may represent shots. In this example, system 200 may not have information about the segmentation of scenes but may be able to identify each shot. For example, detection of shots may simply include detecting a contiguous series of frames, which represent the most basic units of videos, using pixel-based information. In this example, subsegment units 304(1)-(5) may be pre-segmented to enable each subsegment unit to be transformed into embeddings, such as embeddings 306(1)-(5), with each embedding representing a modality of data for a single subsegment.

In some examples, embeddings 306(1)-(5) may represent pretrained sets of multimodal embeddings. In these examples, system 200 may use pretrained models to identify subsegment units 304(1)-(5) and convert each subsegment unit to embeddings of different modalities. For example, a video processing model may convert subsegment units 304(1)-(5) into set of embeddings 206(1) of video data, and an audio processing model may convert subsegment units 304(1)-(5) into set of embeddings 206(2) of audio data. In these examples, set of embeddings 206(1) and set of embeddings 206(2) represent different embedding types of the same set of subsegment units of video 204.

Returning to FIG. 1, at step 120, one or more of the systems described herein may encode, by the computing device, the first set of embeddings with a first sequence model trained for the data type of the first set of embeddings and the second set of embeddings with a second sequence model trained for the different data type of the second set of embeddings. For example, an encoding module 214 may, as part of computing device 202 in FIG. 2, encode set of embeddings 206(1) with a sequence model 210(1) trained for data type 208(1) and encode set of embeddings 206(2) with a sequence model 210(2) trained for data type 208(2).

The systems described herein may perform step 120 in a variety of ways. The term “encode,” as used herein, generally refers to a process of converting one type of data, such as a video file, into another specific digital format. The term “sequence model,” as used herein, generally refers to a machine learning model capable of learning from sequential data. Examples of sequence models include, without limitation, recurrent neural networks (RNNs), long short-term memory (LSTM) networks, gated recurrent units (GRUs), bidirectional GRUs (BiGRUs), transformer models, and/or any other suitable type of machine learning model capable of converting data into a single unit of information.

In some embodiments, sequence model 210(1) may be trained with embeddings of additional videos of data type 208(1), and sequence model 210(2) may be trained with embeddings of additional videos of data type 208(2). For example, a separate BiGRU may be pretrained for each data type using annotated scene change data and pretrained multimodal shot embeddings. In this example, each BiGRU may be trained to predict if a shot is at the end of a scene. In the example of FIG. 4, sequences models 210(1)-(2) may be pretrained with videos 204(1)-(3). In this example, embeddings of video data and embeddings of audio data may be derived from each of videos 204(1)-(3). Sequence model 210(1) may then be trained with embeddings of video data, such as set of embeddings 206(1), a set of embeddings 206(3), and a set of embeddings 206(5), to encode embeddings of data type 208(1). Similarly, sequence model 210(2) may be trained with embeddings of audio data, including set of embeddings 206(2), a set of embeddings 206(4), and a set of embeddings 206(6), to encode embeddings of data type 208(2).

In one example, encoding module 214 may encode set of embeddings 206(1) by processing an embedding of set of embeddings 206(1) at a layer of sequence model 210(1), providing an output of each layer to a next layer of sequence model 210(1), and processing a subsequent embedding of set of embeddings 206(1) at the next layer of sequence model 210(1), wherein the subsequent embedding represents a chronologically following subsegment unit of video 204. The term “layer,” as used herein, generally refers to a structure in deep learning models that takes input from a previous layer, transforms data, and provides output to a following layer. In other words, each layer may encode an embedding to transform potentially complex data into a single vector.

Similarly, encoding module 214 may encode set of embeddings 206(2) by processing an embedding of set of embeddings 206(2) at a layer of sequence model 210(2), providing an output of each layer to a next layer of sequence model 210(2), and processing a subsequent embedding of set of embeddings 206(2) at the next layer of sequence model 210(2), wherein the subsequent embedding represents a chronologically following subsegment unit of video 204. In the above examples, BiGRU models may feed an output of each layer to the next layer while updating a hidden state of the model.

As illustrated in FIG. 5, sequence model 210(1) takes embedding 306(1) as an input to a layer 502(1), which then processes the data to create an output 504(1). In this example, some or all of output 504(1) is then fed to a layer 502(2) along with embedding 306(3) as inputs, resulting in an output 504(3). In this example, embedding 306(3) represents a subsegment unit immediately following a subsegment unit of embedding 306(1) in chronological sequence. In this example, each of embeddings 306(1), 306(3), 306(5), 306(7), and 306(9) are fed to each of layers 502(1)-(5), which then creates outputs 504(1), 504(3), 504(5), 504(7), and 504(9), respectively, to be fed into the following layers. In other words, each layer of sequence model 210(1) takes an embedding of set of embeddings 206(1) as input along with the output from a previous layer. Similarly, sequence model 210(2) takes embeddings 306(2), 306(4), 306(6), 306(8), and 306(10) as inputs and generates outputs 504(2), 504(4), 504(6), 504(8), and 504(10), respectively. In this example, each embedding of set of embeddings 206(1) may correspond to an embedding of set of embeddings 206(2). For example, embedding 306(1) may represent data from the same subsegment unit as embedding 306(2), and embeddings 306(3) and 306(4) may both represent the subsegment unit chronologically following embeddings 306(1) and 306(2). Although illustrated as similar layers, layers 502(1)-(5) of sequence model 210(1) may differ from layers 502(1)-(5) of sequence model 210(2), with each model trained to process different types of data of set of embeddings 206(1) and set of embeddings 206(2).

Returning to FIG. 1, at step 130, one or more of the systems described herein may concatenate, by the computing device, a set of first results of the first sequence model with a set of second results of the second sequence model. For example, a concatenation module 216 may, as part of computing device 202 in FIG. 2, concatenate a set of first results 222 of sequence model 210(1) with a set of second results 224 of sequence model 210(2).

The systems described herein may perform step 130 in a variety of ways. The term “concatenate,” as used herein, generally refers to a process of combining two or more sources of data into a single unit, such as by joining strings of data end-to-end. In some examples, set of first results 222 may include a set of outputs of each layer of sequence model 210(1). Similarly, set of second results 224 may include a set of outputs of each layer of sequence model 210(2). In the example of FIG. 5, set of first results 222 includes outputs 504(1), 504(3), 504(5), 504(7), and 504(9), and set of second results 224 includes outputs 504(2), 504(4), 504(6), 504(8), and 504(10). In these examples, each output may include a hidden state of sequence models 210(1)-(2) in addition to data fed to each next layer. In the above examples, BiGRU models that feed outputs of each layer to each next layer may update a separate, internal hidden state, which may be used as a final result of the model. Although illustrated as using two sequence models, the disclosed systems may use any number of sequence models, with each sequence model corresponding to a modality, or data type, for video 204.

In some embodiments, concatenation module 216 may concatenate set of first results 222 with set of second results 224 by concatenating each first result for a subsegment unit of video 204 with a corresponding second result for the subsegment unit. As illustrated in FIG. 6, output 504(1) and output 504(2) of FIG. 5 represent results for the same subsegment unit and are concatenated. Similarly, outputs 504(3)-(4) are independently concatenated, outputs 504(5)-(6) are concatenated, outputs 504(7)-(8) are concatenated, and outputs 504(9)-(10) are concatenated.

Returning to FIG. 1, at step 140, one or more of the systems described herein may detect, by the computing device based on the concatenation, a segment boundary of the video using a neural network. For example, a detection module 218 may, as part of computing device 202 in FIG. 2, detect a segment boundary 228 of video 204 using a neural network 226.

The systems described herein may perform step 140 in a variety of ways. In the above examples, concatenation module 216 may perform late-stage fusion of outputs, rather than early-stage fusion that may concatenate embeddings before input to the layers of a sequence model. In early-stage fusion, the sequence model and neural network 226 may represent a single model that provides segment boundary predictions. In contrast, the systems described herein may combine multiple separate sequence models, such as sequence models 210(1)-(2), for different input modalities with neural network 226 to predict segment boundary 228. In this example, hidden states of the sequence models are concatenated prior to a final output layer, represented by neural network 226. In some examples, neural network 226 may include a multilayer perceptron (MLP) or any other suitable form of machine learning.

In some embodiments, detection module 218 may detect segment boundary 228 by identifying a boundary subsegment unit as segment boundary 228 for a detected segment of video 204, wherein segment boundary 228 includes a chronological beginning of the detected segment or a chronological end of the detected segment. For example, segment boundary 228 may represent the last shot of a scene, with the next shot assumed to be the beginning of a new scene. In these embodiments, detection module 218 may detect segment boundary 228 by calculating a boundary probability for each subsegment unit of video 204 and determining that the boundary probability of the boundary subsegment unit exceeds a predetermined threshold. Additionally, detection module 218 may detect segment boundary 228 by learning a set of parameters for sequence model 210(1), sequence model 210(2), and neural network 226, and by applying the set of parameters to the video. In other words, the disclosed systems may learn the parameters of the aggregate model, which may be learned through annotated datasets, to detect segment boundaries rather than learning parameters of embeddings.

In the example of FIG. 6, neural network 226 may use the concatenated outputs of each subsegment unit to predict a probability that the subsegment unit is a segment boundary. For example, neural network 226 may use outputs 504(1)-(2) to predict a boundary probability 602(1) of 0.93, or 93%, that indicates subsegment unit 304(1) is a segment boundary 228(1). In this example, segment boundary 228(1) may represent a start of segment 302(1) of FIG. 3. Similarly, neural network 226 may use outputs 504(7)-(8) to predict a boundary probability 602(4) of 0.87, or 87%, that indicates subsegment unit 304(4) is a segment boundary 228(2). In this example, segment boundary 228(2) may represent a start of segment 302(2) of FIG. 3. In contrast, boundary probabilities 602(2), 602(3), and 602(5) may be below the predetermined threshold. For example, a predetermined threshold of 0.8 may preclude subsegment 304(5) from being detected as a segment boundary indicating the start of a scene. In other examples, neural network 226 may be trained to detect endings of segments, rather than beginnings, and/or both the start and the end of each video segment.

Returning to FIG. 1, at step 150, one or more of the systems described herein may perform, by the computing device, additional video processing for the video based on the detected segment boundary. For example, a performance module 220 may, as part of computing device 202 in FIG. 2, perform additional video processing for video 204 based on segment boundary 228.

The systems described herein may perform step 150 in a variety of ways. In some examples, performance module 220 may perform tasks such as video summarization, highlights detection, content-based video retrieval, dubbing quality assessment, video editing, and/or other processing tasks that may be improved with data about the start and/or end of video segments. For example, to improve automated clip generation, the systems described herein may avoid crossing scene boundaries to provide a more cohesive clip from a single scene. In another example, segment boundary 228 may be used to identify a natural break in the narrative of video 204 to insert advertisements to minimize disruption to a viewer. Additionally, based on the additional video processing tasks, the systems described herein may detect video boundaries at different granularities. For example, for content search within videos, detecting boundaries of shots or segments may be more appropriate than scene boundaries.

In some examples, identification module 212 may further identify a third set of embeddings, wherein the third set of embeddings includes external data related to video 204, and encoding module 214 may encode the third set of embeddings with a third sequence model trained for the external data. In these examples, concatenation module 216 may further concatenate a set of third results of the third sequence model with set of first results 222 and set of second results 224, and detection module 218 may then detect segment boundary 228 using the concatenation of all of the above.

As illustrated in FIG. 7, a set of embeddings 206(3) may be derived from external data 702 and input to a sequence model 210(3), which may output a set of third results 704. In this example, neural network 226 may then use the concatenation of set of first results 222, set of second results 224, and set of third results 704 to predict segment boundary 228. For example, external data 702 may represent a screenplay that includes scene headers as well as additional information, such as a location and time of day of a scene, that may correspond to scenes and shots. Additionally, external data 702 may include character information that describes the characters in each shot, which may be embedded as inputs for sequence model 210(3). In this example, screenplay dialogue may be generally aligned to other modalities of video data, such as timestamped text or audio processed through natural language processing. To address changes in the screenplay, the disclosed systems may use pretrained text embeddings and/or other modeling methods, such as dynamic time warping (DTW), to account for misalignment and augment the pretrained sequence models. Other types of external data may also be used to provide additional pretrained embeddings, to train sequence models, and/or to generate results for neural network 226.

In some embodiments, the above described systems may further include a training module, stored in memory, that retrains neural network 226 based on detecting segment boundary 228. In these embodiments, the training module may retrain sequence model 210(1) with set of embeddings 206(1) and/or retrain sequence model 210(20 with set of embeddings 206(2). For example, video 204 of FIG. 2 may be added to videos 204(1)-(3) of FIG. 4 to retrain sequence models 210(1)-(2). In other words, segment boundary 228 may be used to annotate video 204, set of embeddings 206(1), and/or set of embeddings 206(2) as additional training data. In these embodiments, the aggregate model that combines sequence models and neural network 226 may be continually improved or updated.

As explained above in connection with method 100 in FIG. 1, the disclosed systems and methods may, by simplifying an overall, aggregate model and accounting for sequential data, outperform more complex traditional models that focus on computer vision techniques. Specifically, the disclosed systems and methods may first use pretrained embeddings and pretrained sequence models to account for different modalities, or types, of video data. Each subsegment of a video that makes up a segment may be embedded with different modalities. By using rich multimodal embeddings to represent video data, the systems and methods described herein may preserve temporal dependencies between subsegments of data that may be specific to each modality, with each modality being encoded separately with separate sequence models.

The disclosed systems and methods may then concatenate the results to perform a final prediction of video segment boundaries. For example, the systems and methods described herein may concatenate hidden states of a sequence model for video embeddings with hidden states of a sequence model for audio embeddings. By performing the fusion later in the machine-learning process, the disclosed systems and methods may be able to preserve latent representations in different modalities of data while enabling each sequence model to remain modular, making the overall model extensible for more modalities of data. This may also enable the disclosed systems and methods to leverage improvements in the foundational models, such as the sequence models, used as inputs to the final predictive layer. Additionally, the systems and methods described herein may use a neural network to predict the probabilities that each embedded subsegment is a segment boundary. The disclosed systems and methods may then use the detected boundaries of a segment to perform additional video processing tasks. Thus, the systems and methods described herein may more accurately and efficiently detect boundaries such as scene boundaries.

Content that is created or modified using the methods described herein may be used and/or distributed in a variety of ways and/or by a variety of systems. Such systems may include content distribution ecosystems, as shown in FIGS. 8-10.

FIG. 8 is a block diagram of a content distribution ecosystem 800 that includes a distribution infrastructure 810 in communication with a content player 820. In some embodiments, distribution infrastructure 810 may be configured to encode data and to transfer the encoded data to content player 820 via data packets. Content player 820 may be configured to receive the encoded data via distribution infrastructure 810 and to decode the data for playback to a user. The data provided by distribution infrastructure 810 may include audio, video, text, images, animations, interactive content, haptic data, virtual or augmented reality data, location data, gaming data, or any other type of data that may be provided via streaming.

Distribution infrastructure 810 generally represents any services, hardware, software, or other infrastructure components configured to deliver content to end users. For example, distribution infrastructure 810 may include content aggregation systems, media transcoding and packaging services, network components (e.g., network adapters), and/or a variety of other types of hardware and software. Distribution infrastructure 810 may be implemented as a highly complex distribution system, a single media server or device, or anything in between. In some examples, regardless of size or complexity, distribution infrastructure 810 may include at least one physical processor 812 and at least one memory device 814. One or more modules 816 may be stored or loaded into memory 814 to enable adaptive streaming, as discussed herein.

Content player 820 generally represents any type or form of device or system capable of playing audio and/or video content that has been provided over distribution infrastructure 810. Examples of content player 820 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 810, content player 820 may include a physical processor 822, memory 824, and one or more modules 826. Some or all of the adaptive streaming processes described herein may be performed or enabled by modules 826, and in some examples, modules 816 of distribution infrastructure 810 may coordinate with modules 826 of content player 820 to provide adaptive streaming of multimedia content.

In certain embodiments, one or more of modules 816 and/or 826 in FIG. 8 may represent one or more software applications or programs that, when executed by a computing device, may cause the computing device to perform one or more tasks. For example, and as will be described in greater detail below, one or more of modules 816 and 826 may represent modules stored and configured to run on one or more general-purpose computing devices. One or more of modules 816 and 826 in FIG. 8 may also represent all or portions of one or more special-purpose computers configured to perform one or more tasks.

Physical processors 812 and 822 generally represent any type or form of hardware-implemented processing unit capable of interpreting and/or executing computer-readable instructions. In one example, physical processors 812 and 822 may access and/or modify one or more of modules 816 and 826, respectively. Additionally or alternatively, physical processors 812 and 822 may execute one or more of modules 816 and 826 to facilitate adaptive streaming of multimedia content. Examples of physical processors 812 and 822 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 814 and 824 generally represent any type or form of volatile or non-volatile storage device or medium capable of storing data and/or computer-readable instructions. In one example, memory 814 and/or 824 may store, load, and/or maintain one or more of modules 816 and 826. Examples of memory 814 and/or 824 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 9 is a block diagram of exemplary components of content distribution infrastructure 810 according to certain embodiments. Distribution infrastructure 810 may include storage 910, services 920, and a network 930. Storage 910 generally represents any device, set of devices, and/or systems capable of storing content for delivery to end users. Storage 910 may include a central repository with devices capable of storing terabytes or petabytes of data and/or may include distributed storage systems (e.g., appliances that mirror or cache content at Internet interconnect locations to provide faster access to the mirrored content within certain regions). Storage 910 may also be configured in any other suitable manner.

As shown, storage 910 may store, among other items, content 912, user data 914, and/or log data 916. Content 912 may include television shows, movies, video games, user-generated content, and/or any other suitable type or form of content. User data 914 may include personally identifiable information (PII), payment information, preference settings, language and accessibility settings, and/or any other information associated with a particular user or content player. Log data 916 may include viewing history information, network throughput information, and/or any other metrics associated with a user's connection to or interactions with distribution infrastructure 810.

Services 920 may include personalization services 922, transcoding services 924, and/or packaging services 926. Personalization services 922 may personalize recommendations, content streams, and/or other aspects of a user's experience with distribution infrastructure 810. Encoding services, such as transcoding services 924, may compress media at different bitrates which may enable real-time switching between different encodings. Packaging services 926 may package encoded video before deploying it to a delivery network, such as network 930, for streaming.

Network 930 generally represents any medium or architecture capable of facilitating communication or data transfer. Network 930 may facilitate communication or data transfer via transport protocols using wireless and/or wired connections. Examples of network 930 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 9, network 930 may include an Internet backbone 932, an internet service provider 934, and/or a local network 936.

FIG. 10 is a block diagram of an exemplary implementation of content player 820 of FIG. 8. Content player 820 generally represents any type or form of computing device capable of reading computer-executable instructions. Content player 820 may include, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 10, in addition to processor 822 and memory 824, content player 820 may include a communication infrastructure 1002 and a communication interface 1022 coupled to a network connection 1024. Content player 820 may also include a graphics interface 1026 coupled to a graphics device 1028, an audio interface 1030 coupled to an audio device 1032, an input interface 1034 coupled to an input device 1036, and a storage interface 1038 coupled to a storage device 1040.

Communication infrastructure 1002 generally represents any type or form of infrastructure capable of facilitating communication between one or more components of a computing device. Examples of communication infrastructure 1002 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 824 generally represents any type or form of volatile or non-volatile storage device or medium capable of storing data and/or other computer-readable instructions. In some examples, memory 824 may store and/or load an operating system 1008 for execution by processor 822. In one example, operating system 1008 may include and/or represent software that manages computer hardware and software resources and/or provides common services to computer programs and/or applications on content player 820.

Operating system 1008 may perform various system management functions, such as managing hardware components (e.g., graphics interface 1026, audio interface 1030, input interface 1034, and/or storage interface 1038). Operating system 1008 may also process memory management models for playback application 1010. The modules of playback application 1010 may include, for example, a content buffer 1012, an audio decoder 1018, and a video decoder 1020.

Playback application 1010 may be configured to retrieve digital content via communication interface 1022 and play the digital content through graphics interface 1026. A video decoder 1020 may read units of video data from audio buffer 1014 and/or video buffer 1016 and may output the units of video data in a sequence of video frames corresponding in duration to the fixed span of playback time. Reading a unit of video data from video buffer 1016 may effectively de-queue the unit of video data from video buffer 1016. The sequence of video frames may then be rendered by graphics interface 1026 and transmitted to graphics device 1028 to be displayed to a user.

In situations where the bandwidth of distribution infrastructure 810 is limited and/or variable, playback application 1010 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 820 may also include a storage device 1040 coupled to communication infrastructure 1002 via a storage interface 1038. Storage device 1040 generally represent any type or form of storage device or medium capable of storing data and/or other computer-readable instructions. For example, storage device 1040 may be a magnetic disk drive, a solid-state drive, an optical disk drive, a flash drive, or the like. Storage interface 1038 generally represents any type or form of interface or device for transferring data between storage device 1040 and other components of content player 820.

Many other devices or subsystems may be included in or connected to content player 820. Conversely, one or more of the components and devices illustrated in FIG. 10 need not be present to practice the embodiments described and/or illustrated herein. The devices and subsystems referenced above may also be interconnected in different ways from that shown in FIG. 10. Content player 820 may also employ any number of software, firmware, and/or hardware configurations.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive a video to be transformed, transform the video, output a result of the transformation to detect a video segment boundary, use the result of the transformation to identify scenes, and store the result of the transformation to further process the video. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying, by a computing device, a first set of embeddings and at least one second set of embeddings for a video, wherein the second set of embeddings comprises a different data type from a data type of the first set of embeddings;
encoding, by the computing device, the first set of embeddings with a first sequence model trained for the data type of the first set of embeddings and the second set of embeddings with a second sequence model trained for the different data type of the second set of embeddings;
concatenating, by the computing device, a set of first results of the first sequence model with a set of second results of the second sequence model;
detecting, by the computing device based on the concatenation, a segment boundary of the video using a neural network; and
performing, by the computing device, additional video processing for the video based on the detected segment boundary.

2. The method of claim 1, wherein the data type comprises at least one of:
a type of video;
a type of audio;
a type of image;
a type of text; or
metadata about the video.

3. The method of claim 1, wherein each embedding comprises a vector representing the data type for a subsegment unit of the video, wherein a segment of the video comprises at least one subsegment unit.

4. The method of claim 3, wherein the subsegment unit of the video comprises at least one of:
a frame;
a shot;
a scene;
a sequence; or
an act.

5. The method of claim 3, wherein encoding the first set of embeddings comprises:
processing an embedding of the first set of embeddings at a layer of the first sequence model;
providing an output of each layer to a next layer of the first sequence model; and
processing a subsequent embedding of the first set of embeddings at the next layer of the first sequence model, wherein the subsequent embedding represents a chronologically following subsegment unit of the video.

6. The method of claim 5, wherein the set of first results comprises a set of outputs of each layer of the first sequence model.

7. The method of claim 3, wherein encoding the second set of embeddings comprises:
processing an embedding of the second set of embeddings at a layer of the second sequence model;
providing an output of each layer to a next layer of the second sequence model; and
processing a subsequent embedding of the second set of embeddings at the next layer of the second sequence model, wherein the subsequent embedding represents a chronologically following subsegment unit of the video.

8. The method of claim 7, wherein the set of second results comprises a set of outputs of each layer of the second sequence model.

9. The method of claim 3, wherein concatenating the set of first results with the set of second results comprises concatenating each first result for the subsegment unit of the video with a corresponding second result for the subsegment unit of the video.

10. The method of claim 3, wherein detecting the segment boundary comprises identifying a boundary subsegment unit as the segment boundary for a detected segment of the video, wherein the segment boundary comprises at least one of:
a chronological beginning of the detected segment; or
a chronological end of the detected segment.

11. The method of claim 10, wherein detecting the segment boundary comprises:
calculating a boundary probability for each subsegment unit of the video; and
determining that the boundary probability of the boundary subsegment unit exceeds a predetermined threshold.

12. The method of claim 1, further comprising:
identifying a third set of embeddings, wherein the third set of embeddings comprises external data related to the video; and
encoding the third set of embeddings with a third sequence model trained for the external data.

13. The method of claim 12, further comprising:
concatenating a set of third results of the third sequence model with the set of first results and the set of second results; and
detecting the segment boundary of the video using the concatenation of the set of first results, the set of second results, and the set of third results.

14. The method of claim 1, further comprising retraining the neural network based on the detected segment boundary.

15. A system comprising:
an identification module, stored in memory, that identifies, by a computing device, a first set of embeddings and at least one second set of embeddings for a video, wherein the second set of embeddings comprises a different data type from a data type of the first set of embeddings;
an encoding module, stored in memory, that encodes, by the computing device, the first set of embeddings with a first sequence model trained for the data type of the first set of embeddings and the second set of embeddings with a second sequence model trained for the different data type of the second set of embeddings;
a concatenation module, stored in memory, that concatenates, by the computing device, a set of first results of the first sequence model with a set of second results of the second sequence model;
a detection module, stored in memory, that detects, by the computing device based on the concatenation, a segment boundary of the video using a neural network;
a performance module, stored in memory, that performs, by the computing device, additional video processing for the video based on the detected segment boundary; and
at least one processor that executes the identification module, the encoding module, the concatenation module, the detection module, and the performance module.

16. The system of claim 15, wherein the first sequence model is trained with embeddings of additional videos of the data type.

17. The system of claim 15, wherein the second sequence model is trained with embeddings of additional videos of the different data type.

18. The system of claim 15, wherein the detection module detects the segment boundary of the video by:
learning a set of parameters for:
the first sequence model;
the second sequence model; and
the neural network; and
applying the set of parameters to the video.

19. The system of claim 15, further comprising a training module, stored in memory, that:
retrains the first sequence model with the first set of embeddings; and
retrains the second sequence model with the second set of embeddings.

20. A computer-readable medium comprising one or more computer-executable instructions that, when executed by at least one processor of a computing device, cause the computing device to:
identify, by the computing device, a first set of embeddings and at least one second set of embeddings for a video, wherein the second set of embeddings comprises a different data type from a data type of the first set of embeddings;
encode, by the computing device, the first set of embeddings with a first sequence model trained for the data type of the first set of embeddings and the second set of embeddings with a second sequence model trained for the different data type of the second set of embeddings;
concatenate, by the computing device, a set of first results of the first sequence model with a set of second results of the second sequence model;
detect, by the computing device based on the concatenation, a segment boundary of the video using a neural network; and
perform, by the computing device, additional video processing for the video based on the detected segment boundary.
